(19) United States
(12) Patent Application Publication
(10) Pub. No.: US 2008/0280463 A1
(43) Pub. Date: Nov. 13, 2008

(54) Rugged Chip Packaging

(75) Inventors: Darryl J. McKenney, Londonderry, NH (US); Michael W. Gust, Westford, MA (US); David G. Persad, Chelmsford, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: MERCURY COMPUTER SYSTEMS, INC., Chelmsford, MA (US)

(21) Appl. No.: 11/746,463

(22) Filed: May 9, 2007

(51) Int. Cl. H01R 12/00

(52) U.S. Cl. 439/65

(57) ABSTRACT

Improved printed circuit boards (PCBs), printed circuit board assemblies (PCBAs) and methods thereof contemplate PCBs with recesses incorporated into planar surfaces thereof adapted to receive respective elongate leads of circuit components. The recesses are sized so as to prevent distal ends of the leads from emerging through the far sides of the boards and, indeed, allow for positioning of the component flush with, or offset above, the board to which they are mounted.

### BACKGROUND OF THE INVENTION

The present invention relates to electronics manufacture and assembly and, particularly, for example, to printed circuit boards (PCBs) with novel component mountings. It has application, by way of non-limiting example, in mounting semiconductor processor chips and other components on densely packed PCBs, e.g., for use in ruggedized environments.

Printed circuit board manufacture begins with design and, more particularly, with specification of electronic components for use in performing a required set of functions, followed by determination of the most efficient and effective way to connect those components on the PCB. Central to the latter, from perspectives of both design and manufacture, is mounting the components.

Basic mounting techniques include through-hole mounting, in which component leads are passed through holes in the PCB and soldered in place, and surface mounting, in which small tabs on the components are soldered directly to the surfaces of the board. During through-hole assembly, for example, an insertion machine cuts each electronic component from a “tape,” forms the component lead in an upside down U-shape, and inserts them in predrilled (and, often, conductively lined) holes in the board. The leads are then clinched and soldered below the board for secure physical attachment and electrical coupling. Components, such as semiconductor processor chips, that are fragile and/or that have high lead densities must typically be placed in specialized sockets before mounting on the board.

Traditional mounting techniques present various problems for the PCB designer and manufacturer. For example, the fact that some components must be placed in sockets necessarily lowers the component density of the resulting assembled boards. This is particularly true of the larger “zero insertion force” (ZIF) sockets that are often used with processor chips and some memory chips. Where required, these ZIF sockets presents further difficulties, such as retention force and fretting corrosion, to name a few.

In traditional assemblies in which conventional (non-ZIF) sockets are used, on the other hand, e.g., to conserve space, the forces required for insertion can ruin some components and, thereby, wreak havoc on assembled PCB production yields. Wipe length is also a problem with conventional sockets.

The use of sockets (ZIF or otherwise), moreover, necessarily increases component height, thereby, increasing the effective “volume” of the assembled PCB. It also places the PCB designer and manufacturer at the mercy of third-party socket vendors, who may not provide (at reasonable cost) socket configurations appropriate for any given PCB layout. Still further, the use of sockets adds additional layers of electrical interconnectivity, thereby increasing the risk of failure, e.g., due to shock, vibration, manufacturing error, and so forth.

In addition, the effective area of the PCB useful for mounting components and accommodating conductive routing lanes (or traces) is adversely affected by pockets that may be provided in the board surface for capacitors coupled to component leads. Through-holes, themselves, reduce routing lanes and can additionally create unwanted signal interference.

Traditional PCB mounting techniques that rely on surface mounted devices, such as ball grid arrays (BGAS) and column grid arrays (CGAs), present their own sets of difficulties. Thermal conductivity (CTE) mismatch, for example, can result in misalignment of components' conductive tabs with the corresponding contacts on the PCB (or corresponding socket). The lack of reliable solder joints, by way of further example, can make BGA and CGA mountings more prone to failure from shock and vibration.

In view of the foregoing, an object of the invention is to provide improved printed circuit board assemblies (PCBAs) and techniques therefore. A related object is to provide such assemblies and methods as increase the effective area for mounting components and providing conductive traces therebetween.

Another object of the invention is to provide such assemblies and methods as reduce the need for sockets in the board thereby reducing any such associated complications.

Yet another object of the invention is to provide such assemblies and methods as are more readily manufactured, thereby, reducing potential damage to a leaded components.

Still another object of the invention is to provide such assemblies and methods as reduce unwanted signal interference.

Yet still another object of the invention is to provide such assemblies (and methods therefor) as are less prone to damage from shock and vibration during manufacture, shipping and/or operational use.

### SUMMARY OF THE INVENTION

The aforementioned are among the objects attained by the invention which provides, in one aspect, a printed circuit board (PCB) adapted to receive elongate leads of circuit components or elements within recesses that retain the leads but do not permit them to pass through the board. Channels provided at the distal ends of the recesses prevent voids or inclusions that might otherwise result during solder-mounting of the leads into the recesses from adversely affecting the physical and electrical integrity of those mounts. The depth of the recesses can, moreover, be adapted relative to the length of the leads such that the respective circuit element remains disposed a distance above (as opposed to flush with) the PCB surface after mounting.

In a more particular aspect of the invention, a printed circuit board as described above includes at least one recess incorporated into a first planar surface thereof. The recess includes a proximal opening for receiving an elongate lead of a circuit element (e.g., a lead of a integrated circuit processor chip). As such, the inner diameter of the proximal opening is adapted to be at least as large as an outer diameter of the elongate lead. Further, the recess includes a distal end adapted to engage with a distal end of the elongate lead such that the distal end of the lead can be retained within the recess at a location intermediate to the first planar surface and an opposing second planar surface of the circuit board.

The distal end of a recess as described above can, according to further aspects of the invention, be adapted to engage the distal end of the elongate lead in any of a variety of manners. For example, the recess can be cup-shaped and can include, for example, a chamfered distal end.

Further aspects of the invention provide a PCB as described above in which the distal end of the recess is in fluid communication with a channel (e.g., a “micro-via”) of the type described above, e.g., that prevents voids or inclusions that might otherwise result during solder-mounting of a lead into the recess from adversely affecting the physical and electrical integrity of that mounting. Such a channel can, according to further aspects of the invention, have an inner diameter that is smaller than an outer diameter of the lead thereby preventing the lead from entering the channel. The channel can extend to any location relative to the first and second planar surfaces of the PCB. For example, the channel can extend to the second planar surface of the circuit board or, alternatively, to a location intermediate to the first and second planar surfaces of the board.

Still further aspects of the invention provide a PCB as described above in which one or more portions of the recess and/or channel are plated, e.g., in order to improve the integrity of the solder-mounted lead.

Other aspects of the invention provide a PCB as described above in which the recess has any of a variety of cross-sections. For example, the proximal opening of the recess can be circular, oval, or so forth. The recess can, accord to further aspects of the invention, be of any of a variety of dimensions. For example, the proximal opening diameter and a depth, each in a range of about 0.001-0.503 inches.

Further aspects of the invention provide a PCB having a plurality of recesses as described above, each for receiving a respective lead of one or more circuit elements. The depths of one or more of those recesses can differ from the depths of one or more others, e.g., to accommodate leads of different lengths and/or to effect varying offsets of the respective circuit elements, when mounted on the PCB.

In other aspects, the invention provides a printed circuit board assembly (PCBA) constructed from a PCB of the type described above. Such a PCBA, according to one aspect of the invention, has at least one circuit element (e.g., a leaded semiconductor processor chip) whose elongate leads are mounted within respective recesses of the board. The recesses retain those respective leads but do not permit them to pass through the board. Channels provided at the distal ends of the recesses prevent voids or inclusions that might otherwise result during the solder-mounting of the leads from degrading the physical and/or electrical integrity of the mounts. The depth of the recesses can be adapted relative to the length of the respective leads such that the circuit element is offset from PCB after mounting, e.g., in order to provide room for capacitors and/or other circuit elements between the circuit element and the board surface.

Further aspects of the invention provide methods for fabricating PCBAs from PCBs as described above. One such method includes providing a printed circuit board having at least one recess incorporated into the surface thereof, as described above. The method can further include positioning a distal end of an elongate lead within the recess and mounting that lead to the recess, e.g., with solder or another compound.

Still further aspects of the invention provide a method as described above in which a circuit element having multiple leads is mounted to the PCB by soldering each of those leads in a respective recess. In related aspects, the PCB recesses are dimensioned relative to the respective circuit elements leads such that the circuit element is flush with, or offset from, the PCB after mounting. In still further related aspects of the invention, a capacitor or other component is mounted is a region between the aforesaid circuit element and an adjacent surface of the PCB to which it is mounted.

The foregoing and other aspects of the invention are evident in the attached drawings and in the text that follows.

### BRIEF DESCRIPTION OF THE DRAWINGS

A more complete understanding of the invention may be attained by reference to the drawings, in which:

FIG. 1 is a representation of a top view of a printed circuit board assembly of the type with which the invention is practiced;

FIG. 2 is a representation of a cross-sectional view of a portion of the printed circuit board assembly of FIG. 1;

FIGS. 3A-3C and 4A-4B are cross-sectional views of circuit component mounting regions of printed circuit boards in accord with the invention;

### DETAILED DESCRIPTION OF THE ILLUSTRATED EMBODIMENT

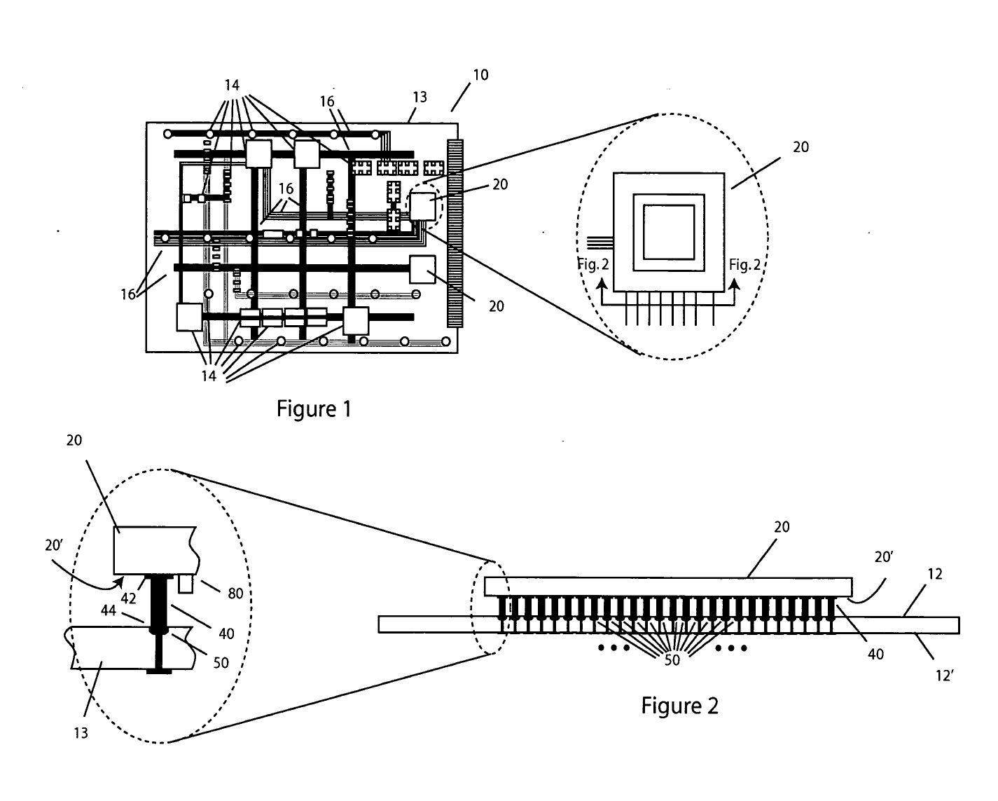

FIG. 1 depicts a printed circuit board assembly (PCBA) 10 according to one practice of the invention. The assembly 10 includes a plurality of circuit components or elements 14, 20 mounted on printed circuit board (PCB) 13 having conductive pathways or traces 16 carrying electrical signals among and between the elements 14, 20.

Circuit components 14, 20 comprise conventional electrical elements of the type used in printed circuit board assemblies. By way of non-limiting example, these can include resistors, capacitors, wire connectors, diodes, semiconductor chips, and the like. The circuit components 14, 20 are selected, mounted and operated in the conventional manner known in the art, as adapted in accord with the teachings hereof. Though a multitude of components 14, 20 are shown in the drawing, other embodiments may include lesser or greater numbers thereof.

Illustrated PCB 13 is a single- or multi-layer board of such type generally known in the art, e.g., fabricated from one or more substrate layers having traces 16 etched or otherwise disposed thereon and/or therein. The PCB 13 can be of generally rectangular shape, as per convention in the art. It can, further, include substantially planar surfaces 12, 12′ (FIG. 2), again, per convention in the art. Of course, PCB 13 can be sized and shaped other than as shown and described here. Though generally fabricated and operated in the conventional manner known in the art, PCB 13 is particularly adapted in accord with the teachings below and elsewhere herein, e.g., for improved mounting of components 14, 20.

FIG. 2 is a cross-sectional view illustrating the manner in which exemplary leaded component 20 is mounted to board 13 in a PCBA accord to the invention. Although only exemplary component 20 is shown in this light and discussed in this regard in the text that follows, it will be appreciated that others of the circuit components 14 may be so mounted in PCBAs according to the invention.

As shown, the component 20 includes one or more elongate leads 40 (e.g., “wire leads”) of the conventional type known in the art and is, accordingly, referred to as a “leaded component” (or “leaded element”)—as distinct from ball grid array (BGA), column grid array (CGA) and other circuit components that include hemispherical or other short and/or thickset tabs (or contacts) in lieu of elongate leads. Here, the elongate leads 40 extend from a board-facing surface 20′ of the leaded component 20 to the planar surface 12 of the circuit board 13. More specifically, each lead 40 has a proximal end 42 and extends from the board-facing surface 20′ of the component 20, terminating in a distal end 44 that is disposed within a corresponding recess 50 of surface 12 of the board 13.

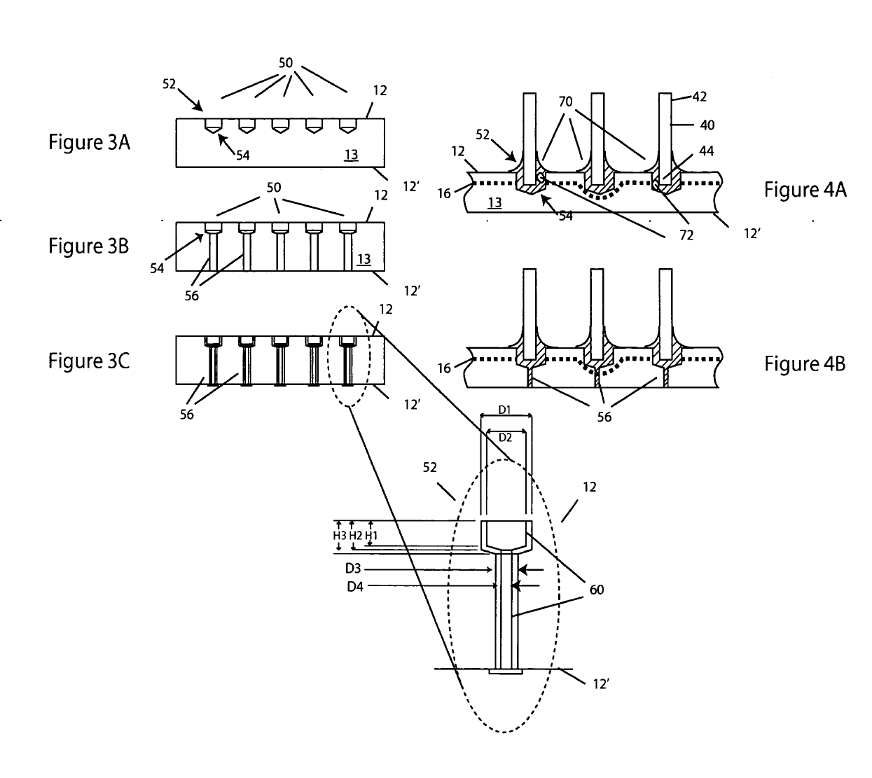

Referring to FIGS. 3A and 4A, the surface 12 of the printed circuit board 13 includes recesses 50 adapted to receive the distal end 44 of respective elongate leads 40 of component 20. While board 13 can include as few as one such recess 50, in the illustrated embodiment it includes as many recesses 50 and in such a pattern as match leads 40 of components 14, 20 which are to be mounted on the board 13. Other embodiments may vary in this regard—providing recesses for the leads of some components 14, 20, while using conventional through-holes, (not shown) for other components 14. Yet still other embodiments include BGA-, CGA- and other surface-mount contacts (not illustrated) or other mounting mechanisms in lieu of, or in addition to, such through-holes.

Each recess 50 includes a proximal opening 52 adapted to receive the distal end 44 of a respective lead 40, as shown. The proximal opening 52 can be of various configurations, for example, of circular, oval, square, or other cross-section (relative to the plane of the surface 12) capable of receiving a lead 40. In the illustrated embodiment, the openings 52 are of circular cross-section. As will be apparent to those skilled in the art, various other such configurations are within the spirit and scope of the present invention.

Generally speaking, the proximal end 52 of recess 50 is sized to permit insertion of lead 40. Thus, for example, end 52 has an inner diameter that equal or greater in size to the outer diameter of the respective lead 40 to be inserted therein. For PCBs 13 that are assembled using automatic lead insertion equipment, the inner diameter of end 52 is preferably about 0.005″ to about 0.05″ larger than the expected outer diameters of the respective leads 40 to be inserted therein and, more preferably, about 0.01″ to about 0.02″ larger. As the lead sizes may vary from component to component—e.g., with typical lead sizes ranging from about 0.03″ to 0.08″, depending on the particulars of the component 14, 20 to be inserted—the inner diameters of proximal ends 52 of recesses 50 of a given PCB 13 may correspondingly range in size.

Each recess 50 further includes a distal end 54 adapted to engage a distal portion 44 of the respective lead so as to retain it within the respective recess 50. The distal end 54 can be configured in any of a number of ways to provide this function. For example, FIG. 3A shows recesses 50 having overall cup-shaped profiles that terminate in distal ends 54 that are chamfered or beveled. Though flat-bottomed ends can be used, such chamfered or beveled ends minimize angular stress during insertion of the respective lead 40 into the recess 50.

The distal ends 54 are positioned at intermediate locations relative to the opposed planar surfaces 12, 12′ of the circuit board 13, thereby, (i) preventing any portion of the inserted lead 40 from passing through the board 13, (ii) allowing routing of additional traces 16 “beneath” the respective recesses 50 (e.g., as shown in FIGS. 4A and 4B), and/or (iii) reducing interference among and/or between traces and leads. In other embodiments, the recesses 50 are cone-shaped, with inner diameters that continuously decrease from the proximal opening 52 to the distal end 54 of the recess 50. Various other such recess profiles are within the spirit and scope of the present invention.

Although recesses 50 of a given board 13 can be of like depth or, alternatively, of varying depth—e.g., dependent on the length of respective leads 40 inserted into them and/or the desired offset (see FIG. 2) between the board-facing surface 20′ of the respective component 20 and the adjacent surface 12 of the board 13. Where a zero offset is desired (i.e., a respective component 20 is flush), the depths of recesses 50 for the leads 40 of a given component are greater than or equal to the length of those respective leads 40. Where a greater offset is desired, the depth of those recesses 50 is preferably less than the lengths of the respective leads. Use of such offsets facilitates inclusion of additional circuit components—such as capacitor 80 shown in FIG. 2—between the board-facing surface 20′ of the component 20 and the adjacent surface 12 of the board, thereby, eliminating the need for soldering those additional components on opposite sides of board 13 and/or for providing pockets in the board to receive them.

FIG. 3B shows an alternate embodiment wherein the distal ends 54 of recess 50 terminate in, and are in fluid-communication with, respective channels 56. In such an embodiment, the inner diameters of channels 56 are smaller than the outer diameters of the respective leads 40, thereby, preventing pass-through of the leads 40. Thus, the inner diameters of channels 56 may be from about 0.005″ to about 0.05″ smaller than the expected outer diameters of the respective leads 40 and, more preferably, about 0.01″ to about 0.02″ smaller. However, to facilitate fabrication of PCB 13, a uniform channel inner diameter may be preferred, e.g., so as to avoid retooling in order to permit channel 56 formation. In this regard, a preferred channel inner diameter can be about 0.01″ to about 0.02″.

The channels 56 can extend any desired depth and directions into the board 13. For example, one or more of the channels 56 can extend a limited length into the board 13 so as to terminate at intermediate locations between the opposed surfaces 12, 12′. Alternatively, or in addition, one or more of the channels can extend from the distal ends 54 of recesses 50 to the opposed planar surface 12′, thereby forming through-holes (albeit ones that are too small to allow complete passage of the respective leads 40, as already noted).

The recesses 50 and/or channels 56 may be electroplated. As shown in this regard in FIG. 3C, with respect to the embodiment of FIG. 3B, one or more layers of electroplating 60 are applied to cup-shaped recesses 50 and channels 56. Such electroplating can be of the type known in the art and can facilitate insertion of leads 40 into the recesses 50 and/or improve solder-bonding therebetween. In the illustrated embodiment, such electroplating also strengthens the recess walls, thereby, ensuring that the distal ends 44 of the leads 40 do not penetrate beyond ends 54. Those skilled in the art will appreciate that the use of any commonly known or combination of commonly known electroplating materials are within the spirit and scope of the present invention.

As above, the proximal end 52 of electroplated recess 50 is sized to permit insertion of lead 40. Thus, for example, such an end 52 has an inner diameter that equal or greater in size to the outer diameter of the respective lead 40 to be inserted therein. For PCBs 13 that are assembled using automatic lead insertion equipment, the inner diameter of electroplated end 52 is preferably about 0.005″ to about 0.05″ larger than the expected outer diameters of the respective leads 40 and, more preferably, about 0.01″ to about 0.02″ larger. Again, as above, since the leads 40 may have different outer diameters from one another, the inner diameters of electroplated proximal ends 52 of recesses 50 of a given PCB 13 may correspondingly range in size.

Also as above, the inner diameters of electroplated channels 56 are smaller than the outer diameters of the respective leads 40, thereby, preventing pass-through of the leads 40. Thus, the inner diameters of electroplated channels 56 may be from about 0.005″ to about 0.05″ smaller than the expected outer diameters of the respective leads 40 and, more preferably, about 0.01″ to about 0.02″ smaller. Again, however, to facilitate fabrication of PCB 13, a uniform electroplated channel inner diameter may be preferred, e.g., so as to avoid retooling in order to permit channel 56 formation. In this regard, a preferred electroplated channel inner diameter can be about 0.01″ to about 0.02″.

FIG. 3C illustrates dimensions D1-D4 of electroplated recesses 50 and channels 56 according to one practice of the invention. In this embodiment, all electroplated recesses 50 on PCB 13 are like-sized (subject to manufacturing tolerances), e.g., as opposed to varying depending on respective lead 40 size. This is likewise true of electroplated channels 56.

In the illustrated embodiment, prior to electroplating, the diameter D1 of the proximal opening 52 of the recess 50 ranges from about 0.001 inches to about 0.503 inches and, more typically, from about 0.005 inches to about 0.250 inches. Following electroplating, the diameter of the proximal opening 52 the diameter D2 of the electroplated proximal opening 52 can range from about 0.002″ to about 0.250″. Likewise, prior to electroplating, the diameter D3 of the channel 56 can range from about 0.005 inches to about 0.500 inches, and a plated diameter D4 can range from about 0.002 inches to about 0.500 inches.

Referring to the inset of FIG. 3C, in the illustrated embodiment of the invention, recesses 50 have depths H1, H2, H3, as shown. H1, the depth the proximal opening 50 to the distal end 54 after electroplating ranges from about 0.002″ to about 0.250″. H2, the depth from the proximal opening 52 to a proximal end of chamfered section leading to the distal end 54 after electroplating ranges from about 0.004″ to about 0.255″. H3, the depth from the proximal opening 52 to the distal end 54 of the pre-electroplated recess 50, ranges from about 0.002″ to about 0.250″. Corresponding depths are utilized in embodiments without electroplating (e.g., as shown in FIG. 3B).

Those skilled in the art will appreciate that the dimensions and ranges specified above are merely examples and various other such diameters are within the spirit and scope of the present invention.

FIGS. 4A and 4B show distal portions 44 of a plurality of leads 40 of components 20 are physically secured within corresponding recesses 50—and electrically coupled, e.g., to traces 16 on or in the board 13—by solder-bonding. FIGS. 4A and 4B illustrate this for recesses 50 that lack and include channels 56, respectively. Though such bonding can be achieved with soldering paste 70, as shown in the drawing, those skilled in the art will appreciate that various other bonding processes and/or materials that achieve physical and electrical coupling of the leads and boards 13 are within the spirit and scope of the present invention.

As shown in FIGS. 4A-4B, use of channels 56 that are in fluid communication with recesses 50 can provide various advantages vis-a-vis bond integrity. Particularly, as shown in FIG. 4A, solder-bonding the leads 40 into a recess 50 that lacks a channel 56 can produce inclusions or voids 72, as a result of out-gassing, trapped gasses or otherwise. However, as shown in FIG. 4B, the presence of a channel 56 in communication with a recess 50 can substantially reduce the possibility of such inclusions 72 forming near the recess 50, as the channel 56 can act to vent any excess gas produced during solder-bonding.

In addition to the foregoing, embodiments of the invention include methods of fabricating PCBs 13 and PCBAs 10 as described above. In one embodiment, such a method includes providing a printed circuit board 13 having one or more recesses 50 of the type described above incorporated therein. Such recesses can be formed in a printed circuit board that is otherwise of conventional construction by etching, molding, drilling, laser-cutting or otherwise. The method further includes positioning the distal ends 44 of elongate leads 40 of a components 14, 20 to be assembled to the PCB 13 within respective recesses 50 thereof. Such insertion can be achieved by manual or automated techniques of the type known in the art, as adapted in accord with the teachings hereof. Those leads 40 are, then, secured in the respective recesses 50 by solder-bonding, or otherwise, in a manner known in the art as adapted in accord with the teachings above.

In alternate embodiments, a method as described above additionally includes sizing one or more of the leads 40 and/or recesses 50 such that one or more of the respective components 14, 20 are disposed offset from the surface of the PCB 13, when the distal ends 44 of those leads 40 are set within the respective recesses 50. Such a method can additionally include coupling one or more of the leads 40 to additional elements 80, as shown in the drawings and described above.

Advantages of boards, board assemblies and methods according to the invention is that they increase the board effective surface area (and volume, in the case of multi-layer boards) for mounting circuit components and providing conductive traces therebetween. Further advantages is that they reduce the need for sockets, thereby, reducing chip (and other socketed component) “footprints” and other associated complications. Still further advantages are that they are more readily manufactured and reduce potential damage to a leaded components. Moreover, they provide PCBAs with reduced signal interference, e.g., among and between adjacent traces and leads. Yet another advantage is that they provide PCBAs that are less prone to damage from shock and vibration during manufacture, shipping and/or operational use.

Described above are devices and methods meeting the aforementioned objects. It will be appreciated that the embodiments shown and discussed here are merely examples of the invention and that other embodiments, incorporating changes with respect thereto, fall within the scope of the invention. In view thereof, what is claimed is:

In view of the foregoing, what I/We claim is:

1. In a printed circuit board, the improvement comprising
at least one recess incorporated into a first planar surface of the printed circuit board,
the recess having a proximal opening for receiving an elongate lead of a circuit element,
the inner diameter of the proximal opening being at least as large as an outer diameter of the elongate lead,
the recess having a distal end adapted to engage with a distal end of the elongate lead, thereby retaining the distal end of the lead within the recess at a location intermediate to the first planar surface and an opposing second planar surface of the circuit board.

2. In the printed circuit board of claim 1, the further improvement comprising a plurality of said recesses, each for receiving a respective elongate lead of a circuit element.

3. In the printed circuit board of claim 1, the further improvement wherein the recess is cup-shaped.

4. In the printed circuit board of claim 1, the further improvement wherein the distal end of the recess is in fluid communication with a channel having a inner diameter that is smaller than an outer diameter of the lead.

5. In the printed circuit board of claim 4, the further improvement wherein the channel extends to the second planar surface of the circuit board.

6. In the printed circuit board of claim 1, the further improvement comprising a channel having a proximal end that is in fluid communication with the distal end of the recess.

7. In the printed circuit board of claim 6, the further improvement wherein a distal end of the channel extends to the second planar surface of the circuit board.

8. In the printed circuit board of claim 6, the further improvement wherein a distal end of the channel extends to a location intermediate to the first and second planar surfaces of the circuit board.

9. In the printed circuit board of claim 1, the further improvement wherein a diameter of the proximal opening of the recess ranges from about 0.001 inches to about 0.503 inches.

10. In the printed circuit board of claim 1, the further improvement wherein the distal end includes a distal opening, the diameter of the distal opening being less than the diameter of the proximal opening.

11. In the printed circuit board of claim 10, the further improvement comprising a plated through-hole extending from the distal opening of the recess.

12. In the printed circuit board of claim 11, the further improvement wherein a diameter of the plated through hole is in the range of about 0.005 inches to about 0.503 inches.

13. In the printed circuit board of claim 1, the further improvement wherein the depth of the recess is in the range of about 0.1 inches to about 0.503 inches.

14. A printed circuit board, comprising:
a recess incorporated into a first planar surface of the printed circuit board, the recess having a proximal opening and a distal end, the distal end adapted to engage with a distal end of an inserted, elongated lead, thereby retaining the distal end of the lead within the recess at a location intermediate to the first planar surface and an opposing second planar surface of the printed circuit board.

15. The printed circuit board of claim 14, wherein the recess has an inner diameter at least at the proximal opening that is at least as large as an outer diameter of the lead.

16. The printed circuit board of claim 15, wherein the distal end of the recess is in fluid communication with a channel having a inner diameter that is smaller than an outer diameter of the lead.

17. The printed circuit board of claim 16, wherein the channel extends to the second planar surface of the printed circuit board.

18. The printed circuit board of claim 15, comprising a channel having a proximal end that is in fluid communication with the distal end of the recess.

19. The printed circuit board of claim 18, wherein a distal end of the channel extends to the second planar surface of the printed circuit board.

20. The printed circuit board of claim 18, wherein a distal end of the channel extends to a location intermediate to the first and second planar surfaces of the printed circuit board.

21. The printed circuit board of claim 16, wherein a distal portion of the recess is chamfered.

22. The printed circuit board of claim 14, wherein the recess is cup-shaped.

23. The printed circuit board of claim 14, wherein an inner wall of the recess includes a layer of electroplating.

24. A device, comprising:
a circuit board,
the circuit board comprising a plurality of recesses, each being incorporated into a planar surface of the circuit board and having a proximal opening for receiving an elongate lead of a circuit element, the inner diameter of the proximal opening being at least as large as an outer diameter of the elongate lead, the recess having a distal end adapted to engage with a distal end of the elongate lead, thereby retaining the distal end of the lead within the recess at a depth intermediate to the aforesaid planar surface and an opposing planar surface of the circuit board,
wherein the depth of at least one said recess differs from a depth of at least another said recess.

25. A circuit device, comprising:
a printed circuit board having at least one recess incorporated into at least one planar surface of the printed circuit board, the recess having a proximal opening and a distal end, the distal end adapted to engage a distal end of an inserted, elongated lead thereby retaining the distal end of the lead within the recess; and
a leaded device having at least one elongate lead, a distal portion of the lead being secured within the recess so as to place the leaded device into electrical communication with the printed circuit board.

26. The circuit device of claim 25, wherein the elongate lead is substantially pin-shaped.

27. The circuit device of claim 26, wherein the lead has a length greater than a depth of the recess thereby allowing the leaded device to be positioned a distance above the printed circuit board when the distal portion of the lead is securely positioned within the recess.

28. The circuit device of claim 27, wherein a capacitor is coupled to a board-facing surface of the leaded device.

29. The circuit device of claim 28, further comprising a plurality of leads extending from the leaded device, a distal end of each lead securely positioned within a plurality of corresponding recesses.

30. The circuit device of claim 25, further comprising a soldering material substantially filling the recess so as to securely position the lead within the recess.

31. A method of engaging a leaded device to a printed circuit board, comprising:
providing a printed circuit board having a printed circuit board having at least one recess incorporated into at least one planar surface of the printed circuit board, the recess having a proximal opening and a distal end, the distal end adapted to engage a distal end of an inserted, elongate lead thereby retaining the distal end of the lead within the recess;
positioning a distal end of a elongate lead within the recess, a proximal end of the lead coupled to a leaded device; and
securely engaging the distal end of the lead to the recess.

32. The method of claim 31, further comprising:
positioning a plurality of leads within a plurality of corresponding recesses, the proximal end of each lead coupled to a board-facing surface of the leaded device.

33. The method of claim 32, wherein at least one elongate lead has a distinct length as compared to at least one other elongate lead thereby allowing for the first elongate lead to engage a first recess having a first depth and allowing for the second elongate lead to engage a second recess of a second depth, the first depth different than the second depth.

34. A method for constructing a printed circuit board, comprising:
providing a printed circuit board having a planar surface, and
incorporating at least one recess into the surface, the recess having a proximal opening and a distal end, the distal end adapted to engage a distal end of an inserted, elongate lead such that the distal end of the elongate lead is retained within the recess.

35. The method of claim 35, further comprising:
electroplating an inner portion of the recess.
